(19) United States
(12) Patent Application Publication
(10) Pub. No.: US 2007/0275150 A1
(43) Pub. Date: Nov. 29, 2007

(54) Nutritional composition and method of making the same

(76) Inventor: Michael P. Ciell, Safety Harbor, FL (US)

Correspondence Address: LARSON AND LARSON, 11199 69TH STREET NORTH, LARGO, FL, 33773, US

(21) Appl. No.: 11/441,882

(22) Filed: May 26, 2006

(51) Int. Cl. A23D 7/00

(52) U.S. Cl. 426/602

(57) ABSTRACT

A dietary supplement composition in the form of a stable emulsion is composed entirely of essential, raw nutrients, in nutritionally effective amounts, that enhances the bioavailability of each individual nutrient. Moreover, this invention is a liquid meal replacement that provides approximately 500 Kcalories without raising blood glucose levels.

### FIELD OF THE INVENTION

This invention relates to a composition for a nutritional supplement and a method of production of the composition. More particularly, the invention relates to compositions of dietary nutrients promoting increased cellular absorption and methods for improving the general health of individuals through oral intake of the nutritional supplements of this invention.

### BACKGROUND OF THE INVENTION

The benefits of omega-3 polyunsaturated fatty acids are well-established. (See, e.g., Hilde, M. A. et al., Effect of Diet and Omega-3 Fatty Acid Intervention on Asymmetric Dimethylarginine. A Randomized Controlled Trial, Nutrition & Metabolism 3:4 (2006).) These “good fat” lipids found naturally in fish oils and flaxseed, are not only promoted for cardiovascular health, but are being increasingly linked to beneficial results for other diseases. (See, e.g., Matsuyama, W. et al., Effects of Omega-3 Polyunsaturated Fatty Acids on Inflammatory Markers in COPD, Chest 128(6): 3817-27 (2005).) Subsequently, the omega-3 oils have also been used in dietary supplements and combined with amino acids, for weight gain in disease-associated weight loss. (See, e.g., Harle, L. et al., Omega-3 Fatty Acids for the Treatment of Cancer Cachexia: Issues in Designing Clinical Trials of Dietary Supplements, Journal of Alternative & Complementary Medicine 11(6): 1039-46 (2005).) Unfortunately, some of the best natural sources of the omega-3 oils, such as flaxseed oil and cod liver oil, are partially altered by normal secretions of bile before they can be transported to the cellular structures that can benefit from their components. In addition, patients with digestive diseases such as Crohn's disease, colitis, gall bladder and/or liver disorders, who need the weight gain assistance and nutrients of dietary supplements, may be compromised in ability to assimilate the nutrients from these oils. A need exists to provide a nutritional composition that will promote the body's use of the oils without loss from bile fluids and pancreatic lipases.

In the early 1950's, Johanna Budwig, PhD., demonstrated that an oil-in-water emulsion of quark (a soft German cheese composed of the milk protein casein) and fresh flaxseed oil would allow the oil to be directly absorbed in the intestine. The emulsion effectively sequesters the oil so that bile acids and pancreatic lipases are not released, thus enabling the triglycerides to be absorbed intact. Moreover, the three double bonds contained in this polyunsaturate are protected from oxidation by binding to the sulfhydral groups in the protein. In this manner, significant health benefits may be effected. (See, Budwig, J., Flaxoil As A True Aid Against Arthritis, Heart Infarction, Cancer and Other Diseases (English ed., 1994).) A need exists for a nutritional composition that employs the oil-in-water emulsion providing enhanced health benefits due to direct absorption in the intestine. The present invention provides this beneficial emulsion but utilizes, not quark, but rather valuable whey as the protein base.

Whey, a milk protein, was for years considered to be only a waste by-product of cheese manufacturing. Today it is a popular dietary protein recognized to contain essential amino acids in higher concentrations than vegetable protein sources and found to be better absorbed in comparison to free amino acid solutions. (See, e.g., Marshall, Keri, Therapeutic Applications of Whey Protein, Alternative Medicine Review 9(2) (2004).) This efficacy of absorption has important consequences with respect to health and disease therapy. Whey protein concentrates have been researched extensively in the prevention and treatment of cancer with its glutathione stimulating mechanism thought to be the source of whey's immune system enhancement. (See id.) Undenatured, biologically active whey is rich in cystine. Through the digestive process cystine yields two molecules of cysteine, a key amino acid in the synthesis of glutathione, a potent antioxidant that plays a vital role in the mechanics of cell growth, as well as immune responses. Hepatitis, HIV, prostate and colon cancer, cystic fibrosis, obstructive pulmonary disease, and cardiovascular disease are just some of the conditions for which whey proteins have had positive results. (See, e.g., Tseng, Y. M. et al., Whey Protein Concentrate Promotes the Production of Glutathione by GSH Reductase in the PC12 Cell Line After Acute Ethanol Exposure, Food & Chemical Toxicology, Dec. 14 (2005); Moreno, Y. F. et al., Features of Whey Protein Concentrate Supplementation in Children with Rapidly Progressive HIV Infection, Journal of Tropical Pediatrics 10 (2005); Bounous, G. et al., The Antioxidant System, Anticancer Research 23(2B): 1411-15 (2003); Kent, K. D. et al., Effect of Whey Protein Isolate on Intracellular Glutathione and Oxidant-Induced Cell Death in Human Prostate Epithelial Cells, Toxicology in Vitro 17(1): 27-33 (2003); Bounous, G. et al., Whey Protein Concentrate and Glutathione Modulation in Cancer Treatment, Anticancer Research 20(6C): 4785-92 (2000); Watanabe, A. et al., Nutritional Therapy of Chronic Hepatitis by Whey Protein, Journal of Medicine 31(5-6):283-302 (2000); Loathian, Bryce et al., Treatment of Obstructive Airway Disease With a Cysteine Donor Protein Supplement, Chest 117:914-16 (2000); Smithers, Geoffrey et al., Symposium: Advances in Dairy Foods, Journal of Dairy Science 79:1454-59 (1996).) Lactoferrin and immunoglobulins are two more immune-enhancing components found in whey whose optimal benefits are absent in today's modern diet with its extensive processing methods, i.e., pasteurization, hydrogenation, etc. (See, e.g., Marshall, Keri, Therapeutic Applications of Whey Protein, Alternative Medicine Review 9(2) (2004).) A need exists to provide a nutritional composition that will promote the body's synthesis of glutathione, particularly in diseased patients that can immediately benefit from its antioxidant qualities, as well as provide other needed dietary components from the absorption of whey.

Plant gums have long been used as thickeners and emulsifiers, allowing oils to remain dispersed and in suspension in liquids. These mucopolysaccharides (i.e., glycosaminoglycans) are complex carbohydrates also known to be an important source of fiber in the diet. More recently, university researchers in the United States are studying plant gums as a potential means for more effective delivery of medications within the human body, providing better absorption of drugs.

Aloe vera's beneficial properties also have been widely researched and established. Among Aloe's benefits cited in literature are positive results in dermatological lesions and anti-tumor activity, as well as Aloe's success with induction of hypoglycemic activity and as an antibacterial agent. (See, e.g., Maddocks-Jennings, W. et al., Novel Approaches to Radiotherapy-Induced Skin Reactions: A Literature Review, Complementary Therapies in Clinical Practice 11(4): 224-31 (2005); Pecere, Teresa et al., Aloe-emodin Is a New Type of Anticancer Agent with Selective Activity against Neuroectodermal Tumors, Cancer Research 60: 2800-04 (2000); Lin, S. Y. et al., Effect of Inhibition of Aloe-emodin on N-acetyltransferase Activity and Gene Expression in Human Malignant Melanoma Cells, Melanoma Research 15(6): 489-94 (2005); Rajasekaran, S. et al., Mineral Contents of Aloe Vera Leaf Gel and Their Role on Streptozotocin-Induced Diabetic Rats, Biological Trace Element Research 108(1-3): 185-96 (2005); Hatano, T. et al., Effects of Tannins and Related Polyphenols on Methicillin-Resistant Staphylococcus Aureus, Phytochemistry 66(17):2047-55 (2005).) Aloe vera is also recognized to benefit the absorption of particular nutrients within the human body. (See, e.g., Vinson, J. A. et al., Effect of Aloe Vera Preparations on the Human Bioavailability of Vitamins C and E, Phytomedicine 12 (10): 760-65 (2005).) This is true, not only of the extracted gel from the inner leaves, but also of the entire leaf of the Aloe vera plant. (See id.)

Trehalose or D-trehalose dihydrate (alpha-D-glucopyranosyl-alpha-D-glucopyranoside) is a naturally occurring disaccharide that exists in animals, plants, and microorganisms, as well as being found in fermented foods. Trehalose is mildly sweet (45% as sweet as sucrose) and is low glycemic, elicting only a small insulin response. Trehalsoe stabilizes cell membranes when they encounter conditions of hyperthermia or hypothermia, dehydration, or oxidation. In the latter regard, it is being used in Japan to “dust” polished rice so as to prevent lipid peroxidation on the surface of the “naked” rice grain. Trehalose has been shown to interfere with beta-amyloid 40 and 42 peptide aggregation and toxicity in mammalian models. It warrants further study in neurodegenerative diseases such as Huntington's, Parkinson's and Alzheimer's. (See, Tanaka, M. et al., Trehalose Aalleviates Polyglutamine-mediated Pathology in a Mouse Model of Huntington's Disease. Nature Medicine, Jan. 18. (2004); Liu, R. et al., Trehalose Differentially Inhibits Aggregation and Neurotoxicity of Beta-Amyloid 40 and 42. Neurobiology of Disease, Oct:20 (1): 74-81 (2005).)

D-ribose is a naturally occurring 5-carbon sugar (a pentose) that is essential for energy production, as well as serving as the carbohydrate skeleton for DNA and RNA. D-ribose is produced in the body from glucose via de novo synthesis (the “Pentose Phosphate Shunt”), as well as possible production as a by-product of the oxidative phosphoralization cycle. In this manner ribose may be produced more quickly than through de novo synthesis. Numerous studies give evidence that supplementation of the diet with D-ribose enhances energy production. (See, e.g., Van Gammeran, D. et al., The Effects of Four Weeks of Ribose Supplementation on Body Composition and Exercise Performance in Healthy Young Male Recreational Body Builders: A Double-Blind, Placebo Controlled Trial. Current Therapeutic Research 36:8, 486-95 (2002).) Increased mitochondrial energy production (ATP) has also been shown to increase heart function in the parameters of stroke volume index, ejection fraction and diastolic ventricular volume. (See, e.g., Illien, Stefan et al., Ribose Improves Myocardial Function in Congestive Heart Failure, Federation of American Societies for Experimental Biology Journal 15:5, A1142 (2001); Plial, Wilhelm, et al., Effects of Ribose on Exercise-Induced Ischemia in Stable Coronary Artery Disease. The Lancet 340: 507-10 (1992).)

Rooibos, the source of an herbal tea, contains high level of polyphenols and, as such, is suggested in the literature as a potential source of anti-oxidant activity. (See, e.g., Joubert, E. et al., Antioxidant and Pro-Oxidant Activities of Aqueous Extracts and Crude Polyphenolic Fractions of Rooibos, Journal of Agricultural & Food Chemistry 53(26):10260-67 (2005).) Stevia is a plant from the genus Asteraceae and contains naturally occurring sweet diterpene glycosides in its leaves. Research on animal models treated with stevia has had positive results with blood glucose levels, suggesting that further studies for the treatment of diabetes may be warranted. (See Chen, T. H. et al., Mechanism of the Hypoglycemic Effect of Stevioside, a Glycoside of Stevia Rebaudiana, Planta Medica 71(2): 108-13 (2005); Chang, J. C. et al, Increase of Insulin Sensitivity by Stevioside in Fructose-Rich Chow-Fed Rats, Hormone & Metabolic Research 37(10):610-16 (2005); Raskovic, A. et al., Glucose Concentration in the Blood of Intact and Alloxan-Treated Mice after Pretreatment with Commercial Preparations of Stevia Rebaudiana, European Journal of Drug Metabolism & Pharmacokinetics 29(2):87-90 (2004).) Maintenance of blood glucose levels in the normal or near normal range is recognized as an important goal in diabetes treatment. (See Franz, Marion J. et al., Nutrition Principles and Recommendations in Diabetes, Diabetes Care 27(1):S36-46 (2004). See also Aronoff, Stephen L. et al., Glucose Metabolism and Regulation: Beyond Insulin and Glucagon, Diabetes Spectrum 17(3): 183-90, 184 (2004) (“[H]ormones of the body are designed to maintain circulating glucose concentrations in a relatively narrow range.”).)

Nutritional supplements using whey protein have been available—frequently, however, combined with refined fruit juices for palatability as described in U.S. Pat. No. 5,641,531. Other supplements have combined both whey protein with lipids, but the lipid sources used are not exclusive to the important omega-3 oils. An example is found in U.S. Pat. No. 6,592,863. Still additional nutritional supplements utilize the valuable contributions of plant carbohydrates as described in U.S. Pat. No. 6,929,807.

A need yet exists to provide a nutritional composition, and a method of producing said composition, utilizing the valuable nutrients found in whey protein, omega-3 oils and plant carbohydrates from natural sources, while ensuring maximum absorption of these nutrients through the use of natural, potent emulsifying agents that promote direct absorption in the intestine.

### SUMMARY OF THE INVENTION

The present invention provides a nutritional supplement, and a method of producing a supplement, in an emulsified form to promote increased cellular absorption of valuable nutrients and, thereby, promote health. In particular the invention relates generally to a nutritional composition adapted for mixing with water to form a liquid composition suitable as a total meal replacement or as a means of delivering valuable nutrients in addition to meals.

An example of such a composition is the nutritional supplement comprising:
(1) a protein base of whey protein concentrate in an amount of about 80% by weight of the dry ingredients;
(2) an emulsifying phase of mucopolysaccharides (plant gums) and whole leaf Aloe vera, plus flavor and sweetener additives, in an amount of about 20% by weight of the dry ingredients;
(3) an oil phase of omega-3 oils in an amount of about 60 milliliters for every 25 grams of dry ingredients.

### The composition as defined above is mixed with an ingestible liquid, preferably water, whereby the addition of 240 milliliters of water will provide approximately 500 Kcalories of energy.

### DETAILED DESCRIPTION OF THE INVENTION

The invention is directed to a composition having an oil phase component comprising flaxseed oil and cod liver oil, a protein base component of whey protein concentrate, and an emulsifying phase component comprising three plant gums plus whole leaf Aloe vera, in addition to rooibos tea powder, sweeteners, and natural flavors.

The percent range of each component of the oil phase is 0.001% to 99.999% of the total percent of the oil phase for both flaxseed oil and cod liver oil, with a preferred percent total of 75% flaxseed oil and 25% cod liver oil.

Approximately 73% of the weight of the emulsifying phase component is comprised of polymeric acetylated mannans with an average molecular weight of 1.6 million Daltons from the inner leaf gel of the Aloe vera plant, gum tragacanth, arabinogalactan, and a 200 to 1 extract of whole leaf Aloe vera. The range in weight of these four primarily gum components may vary from approximately 0.01% to 72.99% of the total weight of the emulsifying phase with equal parts of each of the four components preferred. The remaining approximately 27% weight of the total weight of the emulsifying phase is comprised of 100% rooibos tea powder, sweeteners such as pure stevia extract, D-trehalose dihydrate and D-ribose, and natural flavors, such as nutmeg, cinnamon, vanilla, carob and chocolate. Due to variations in qualities of flavor and sweetness of these natural products, the range in weight of the components in the remaining approximately 27% of the total weight of the emulsifying phase may vary from approximately 0.01% to 20% by weight rooibos tea powder with 12.50% preferred; approximately 5% to 95% by weight sweeteners with 5% to 15% pure stevia extract and 0.01% to 95% by weight D-trehalose dihydrate or D-ribose with 12.50% stevia extract and 74.5% of either D-trehalose dihydrate or D-ribose preferred; approximately 0.01% to 25% by weight each of nutmeg and cinnamon or natural vanilla and organic cocoa or carob powder with 0.25% weight each of nutmeg and cinnamon or natural vanilla and organic cocoa or carob powder preferred.

The protein base component is preferably comprised of a native, biologically active whey protein concentrate containing high levels of lactoferrin, immunoglobulins and covalently bonded cysteine.

The protein and emulsifying phase components will comprise 80% and 20% respectively of the total weight of the dry ingredients of the prepared supplement. For example, twenty grams in weight of protein base will be combined with five grams in weight of the emulsifying phase for mixing with sixty ml of the oil phase and 240 ml of water, preferably distilled, spring or water treated by reverse osmosis. This provides a liquid meal replacement of approximately 500 Kcalories. One percent low fat organic milk may be substituted for the water at the consumer's preference.

### EXAMPLE 1

The emulsifying and protein phase components are combined together into 25 gram sealed foil packets for distribution, each with a 60 ml container of the oil phase. Into each 25 gram packet is placed:
20 grams Proserum®, a hormone free, antibiotic free whey protein concentrate obtained from Wellwisdom, L.L.C. of San Diego, Calif.;
0.9 grams Manapol Gold® (acetylated polymannans from the aloe plant) obtained from Carrington Labs, Irving, Tex.;
0.9 grams gum tragacanth;
0.9 grams arabinogalactan (derived from larch tree extract)
0.9 grams freeze-dried 200:1 extract of stabilized whole leaf Aloe vera obtained from Coats Aloe Int'l in Garland, Tex.;
0.18 grams 100% rooibos tea powder
0.18 grams pure stevia extract
1.0 gram trehalose (pharmaceutical grade) obtained from NutriScience Innovations, L.L.C. of Fairfield, Conn.
0.004 grams natural cinnamon
0.004 grams natural nutmeg.

The 60 ml container of the oil phase is comprised of 45 ml of flaxseed oil from Barlean's Organic Oils of Ferndale, Wash. and 15 ml of Norwegian cod liver oil from Nordic Naturals of Watsonville, Calif. Instructions are given to insert contents of one packet into a 420 ml (14 ounce) glass or other container, add the oil phase and whisk rapidly until a primary emulsion forms, then add 240 ml of distilled water and whisk again until a stable, elegant oil-in-water emulsion has formed with a total volume of approximately 360 ml (12 ounces).

### EXAMPLE 2

A bulk supply of the emulsifying and protein base components is provided in separate containers, with the oil phase provided or obtained as needed for preparation of the nutritional composition by individuals or practitioners.

Protein phase base:
5 kilograms Proserum®, a hormone free, antibiotic free whey protein concentrate obtained from Wellwisdom, L.L.C. of San Diego, Calif.

Emulsifying phase:
228 grams Manapol Gold® (acetylated mannose from aloe plant) obtained from Carrington Labs, Irving, Tex.;
228 grams gum tragacanth;
228 grams arabinogalactan (derived from larch tree extract);
228 grams freeze-dried 200:1 extract of stabilized whole leaf Aloe vera obtained from Coats Aloe Int'l in Garland, Tex.;
42.25 grams 100% rooibos tea powder;
42.25 grams pure stevia extract;
252 grams D-trehalose obtained from NutriScience Innovations, L.L.C. in Fairfield, Conn.;
1.5 grams natural cinnamon;

Oil phase
11.25 liters flaxseed oil;
3.75 liters cod liver oil.

A twenty gram scoop is provided in the protein phase base container and a five gram scoop in the emulsifying phase base container. A respective scoop from each of the protein phase base and emulsifying base containers is filled and mixed together. To this mixture is added, whisking rapidly to an emulsion, 60 ml of the oil phase—preferably 45 ml of flaxseed oil and 15 ml of Norwegian cod liver oil. To this approximately 240 ml of distilled, other pure water, or 1% low fat organic milk is added and whisked until mixed for a total volume of approximately 360 ml or 12 ounces per serving.

### EXAMPLE 3

Other possible bulk preparations of the nutritional composition can be made as follows:
(1) Whey protein concentrate—80% of the total weight of the dry components;
(2) Plant gums (mucopolysaccharides)—approximately 15% of the total weight of the dry components;
(3) Natural sweeteners—approximately 4% of the total weight of the dry components;
(4) Natural flavoring and rooibos tea powder—approximately 1% of the total weight of the dry components;
(5) Omega-3 oils—approximately 60 ml per 25 grams of dry components.

A nutritional composition providing approximately 500 Kcalories of energy is provided by rapidly whisking approximately 25 grams in weight of the dry components with 60 ml of the oil components. To this approximately 240 ml of distilled, other pure water, or 1% low fat organic milk is added and stirred until mixed for a total volume of approximately 360 ml or 12 ounces of the nutritional supplement.

### EXAMPLE 4

Other preparations of the nutritional composition are produced as follows:

| | |
|---|---|
| Total Dry | |
| Component Weight | Ingredient |

Protein phase base:

| | |
|---|---|
| 80% | Whey protein concentrate - |
| | Proserum ®, a hormone free, antibiotic free whey |
| | protein concentrate obtained from Wellwisdom, |
| | L.L.C. of San Diego, California. |

Emulsifying phase:

| | |
|---|---|
| 15% | (1) PLANT GUMS AND WHOLE |
| | LEAF ALOE VERA: |
| 0.01% to 14.99% | (a) Manapol Gold ® (acetylated |
| | mannose from aloe plant) obtained from |
| | Carrington Labs, Irving, Texas; |
| 0.01% to 14.99% | (b) gum tragacanth; |
| 0.01% to 14.99% | (c) arabinogalactan (derived from |
| | larch tree extract); |
| 0.01% to 14.99% | (d) freeze-dried 200:1 extract of |
| | stabilized whole leaf Aloe vera |
| | obtained from Coats Aloe Int'l in |
| | Garland, Texas; |
| 4% | (2) NATURAL SWEETENERS: |
| 0.20% to 0.60% | (a) pure stevia extract |
| 0.01% to 3.80% | (b) D-trehalose (a disaccharide) |
| | obtained from NutriScience Innovations |
| | in Fairfield, Connecticut, or D-ribose. |
| 1% | (2) NATURAL FLAVORING AND |
| | ROOIBOS TEA POWDER: |
| 0.01% to 0.99% | (a) 100% rooibos tea powder; |
| 0.01% to 0.99% | (b) cinnamon, nutmeg, vanilla, |
| | chocolate or other flavoring |

Oil Phase

| Total Volume Oil Phase | Ingredient |
|---|---|
| 0.001% to 99.999% | Flaxseed oil obtained from |
| | Barlean's Organic Oils of |
| | Ferndale, WA. |
| 0.001% to 99.999% | Cod liver oil obtained from |
| | Nordic Naturals of Watsonville, |
| | CA. |

A nutritional composition providing approximately 500 Kcalories of energy is provided by rapidly mixing approximately 25 grams in weight of the proportionate percent weight dry components with 60 ml of the oil components. The percent weight of the natural flavoring and sweetener will vary because of differences in flavor and sweetness due to fluctuations in growing conditions such as soil quality, rainfall, temperature, etc. To this nutritional composition, approximately 240 ml of distilled, other pure water, or 1% low fat organic milk is added and stirred until mixed for a total volume of approximately 360 ml or 12 ounces of the nutritional supplement.

For the embodiments given in Examples 2, 3 and 4 above, a practitioner adjusts the components of the three phases so as to meet the specific nutritional needs of a particular patient or individual.

### EXAMPLE 5

The nutritional composition was fed to a non-diabetic group of three subjects. The non-diabetic individuals showed no significant change in blood glucose levels after ingestion of approximately 500 Kcalories of energy from one serving of a 25 gram packet of the nutritional composition mixed with 60 ml of the omega-3 oil blend (i.e., 45 ml of Barlean's fresh organic flaxseed oil and 15 ml of Nordic Naturals' cod liver oil) and 240 ml of bottled spring water. The average of the blood glucose levels is as follows:

Non-diabetic Individuals

| | |
|---|---|
| Blood Glucose levels prior to ingestion | 107 mg/dl |
| 30 minutes after ingestion | 108 mg/dl |
| 60 minutes after ingestion | 100 mg/dl |
| 90 minutes after ingestion | 101 mg/dl |
| 120 minutes after ingestion | 100 mg/dl |
| 150 minutes after ingestion | 105 mg/dl |

### EXAMPLE 6

The nutritional composition described in Example 5 was fed to a group of three Type II diabetic subjects recruited from the patient base of Foundational Health Center, L.L.C. (a medical practice located in Largo, Fla.). These patients were newly diagnosed Type II diabetics who were not started on oral hypoglycemic drugs or insulin. The composition was given daily as the morning meal. The diabetic individuals' fasting insulin levels decreased significantly (−1.8 micro Units/mL on average) within six months of starting the regimen, likely indicating an increase in insulin sensitivity.

### EXAMPLE 7

The nutritional composition was given once a day as the morning meal to a 63 year old male chronic obstructive pulmonary disease (COPD) patient. Before starting the regimen the patient was completely housebound and unable to walk up to twelve feet at one time. Within three months of a daily meal of the nutritional composition, the patient was able to take short walks outside. Giving the patient the individual nutrients (i.e., flaxseed oil capsules—3 grams daily and orally administered cod liver oil —1 tablespoonful daily) had produced no change in his condition. No significant change was seen in his pulmonary function tests so increased airflow was not involved. It is postulated that an increase in permeability of the membranes of the alveolar surfaces in the lungs allowed more oxygen to diffuse through the membranes, accounting for an increased exercise tolerance.

In summary, this invention pertains to a nutritional composition providing a supplement of beneficial nutrients and method of producing said nutrients in a manner that promotes and maintains good health. More specifically the invention relates to a nutritional composition providing the nutritional benefit of whey protein, natural carbohydrates and omega-3 oils in an emulsion that increases cellular absorption of the nutrients. The invention assists in correcting the problem created by excess intake of highly refined foods, from which many necessary nutrients have been eliminated during processing. It allows the individual to benefit from the well-researched effects of whey protein, omega-3 oils and plant carbohydrates in a manner that combines all three major components and optimizes absorption.

The above is a detailed description of particular embodiments of the invention. However, it will be within one having skill in the art to make modifications without departing from the spirit and scope of the invention. The composition is not limited to the embodiments described, but includes such modifications and equivalents within the knowledge of one having skill in the art.

Having disclosed the invention, what is claimed follows:

1. A nutritional supplement composition comprising:
dry ingredients of a whey protein phase containing about 80% by weight of total dry ingredients in the supplement, and
an emulsifying phase comprising at least 15% by weight of all dry ingredients, plant gums and whole leaf Aloe vera; and
a lipid source of omega-3 oils containing 60 ml of omega-3 oils for every 25 grams of dry ingredients.

2. The composition according to claim 1 further comprising flavor additives and sweetener additives containing about 5% by weight of all dry ingredients of the supplement.

3. The composition according to claim 2 wherein said sweetener additives are pure stevia extract and D-trehalose.

4. The composition according to claim 2 wherein said sweetener additives are pure stevia extract and D-ribose.

5. The composition according to claim 2 wherein said flavor additives are 100% rooibos tea powder and other natural flavors selected from the group consisting of cinnamon, nutmeg, vanilla, chocolate, and carob, wherein the tea powder to other natural flavors is in a weight ratio of about 3:1.

6. The composition according to claim 2 wherein said sweetener additives are D-trehalose and pure stevia extract; wherein said flavor additives are 100% rooibos tea powder and natural cinnamon or other optional natural flavors; and wherein the D-trehalose to rooibos tea powder to stevia extract is in a weight ratio of about 6:1:1.

7. The composition according to claim 1 wherein said omega-3 oils are clear, organic, cold-pressed flaxseed oil and molecularly distilled Norwegian cod liver oil.

8. The composition according to claim 7 wherein said flaxseed oil to cod liver oil is in a volume ratio of about 3:1.

9. The composition according to claim 1 wherein said plant gums are acetylated polymannans precipitated from the inner leaf gel of the Aloe vera plant with average molecular weights of 1.6 million Daltons, gum tragacanth, and arabinogalactan; and said whole leaf Aloe vera is a freeze-dried 200:1 extract of stabilized whole leaf Aloe vera.

10. The composition according to claim 9 wherein said plant gums to said whole leaf Aloe vera are in a weight ratio of about 1:1:1:1.

11. The composition according to claim 1 wherein said whey protein is a native, biologically active whey protein concentrate, hormone and antibiotic free.

12. A nutritional supplement composition comprising:
20 grams whey protein concentrate;
about 3.6 grams whole leaf Aloe vera and plant gums wherein the plant gums are selected from the group consisting of acetylated polymannans from the inner leaf gel of the Aloe vera plant with an average molecular weight of 1.6 million Daltons, gum tragacanth, and arabinogalactan;
0.00014 grams to 0.28 grams 100% rooibos tea powder;
0.07 grams to 0.21 grams pure stevia extract;
0.00014 grams to 1.33 grams natural sweetener selected from the group consisting of D-trehalose and D-ribose;
0.00014 grams to 0.35 grams natural flavor selected from the group consisting of cinnamon, nutmeg, vanilla, chocolate, and carob; and
60 milliliters omega-3 oils selected from the group consisting of flaxseed oil and cod liver oil.

13. The composition according to claim 12 wherein the whey protein concentrate, whole leaf Aloe vera, plant gums, rooibos tea powder, stevia extract, natural sweetener, and natural flavor are sealed in a packet separate from the omega-3 oils.

14. The composition according to claim 12 wherein said composition further comprises about 240 milliliters of liquid selected from the group consisting of pure water and 1% low fat organic milk.

15. The composition according to claim 12 wherein the whole leaf Aloe vera and plant gums each comprise from 0.0005 grams to 3.6 grams.

16. The composition according to claim 12 wherein the plant gums comprise from 0.75 grams to 1 gram each of acetylated polymannans with average molecular weights of 1.6 million Daltons, gum tragacanth, and arabinogalactan.

17. The composition according to claim 12 wherein the whole leaf Aloe vera is a freeze-dried 200:1 extract of stabilized whole leaf Aloe vera comprising from 0.75 grams to 1 gram.

18. The composition according to claim 12 wherein the 100% rooibos tea powder comprises about 0.18 grams, the pure stevia extract comprises about 0.18 grams, the natural sweetener comprises about 1 gram, and the natural flavor comprises about 0.008 grams.

19. The composition according to claim 12 containing wherein the omega-3 oils comprise about 45 milliliters flaxseed oil and about 15 milliliters cod liver oil.

20. The composition according to claim 19 wherein said flaxseed oil is clear, organic and cold-pressed.

21. The composition according to claim 19 wherein said cod liver oil is molecularly distilled Norwegian cod liver oil.

22. A method of forming a nutritional supplement composition, the steps comprising:
(a) mixing a dry powder of whey protein concentrate, plant gums, whole leaf Aloe vera, sweetener, and flavor additives;
(b) whisking omega-3 oils with the dry powder of step (a); and
(c) whisking a sufficient amount of liquid from the group consisting of water and 1% low fat milk, with the composition of step (b) to form
a liquid emulsion suitable for drinking by a human.

23. The method of claim 22 wherein about 25 grams of said dry powder is mixed with about 60 milliliters of said omega-3 oils; and then mixed with about 240 milliliters of liquid to produce a final composition of about 360 milliliters or about a 12 ounce serving providing about 500 Kcalories.

24. The method of claim 23 wherein the dry powder is packaged in individual sealed packets for easy measuring of about one 12-ounce serving of nutritional supplement composition, after mixing with said omega-3 oils and said liquid.

25. The method of claim 22 wherein the whey protein concentrate is packaged separately from the other components of the dry powder so as to facilitate easy measuring of the dry powder ingredients from bulk containers, whereby 20 grams of the whey protein concentrate is mixed with 5 grams of the other components of the dry powder, prior to whisking with the omega-3 oils and the sufficient amount of liquid.
